(19) United States
(12) Patent Application Publication
(10) Pub. No.: US 2026/0159021 A1
(43) Pub. Date: Jun. 11, 2026

(54) AIRBAG DEVICE

(71) Applicant: TOYODA GOSEI CO., LTD., Kiyosu-shi (JP)

(72) Inventor: Atsushi NAKAMURA, Aichi (JP)

(21) Appl. No.: 19/411,682

(22) Filed: Dec. 8, 2025

(30) Foreign Application Priority Data
Dec. 9, 2024 (JP) 2024-214680

(51) Int. Cl. B60R 21/239; B60R 21/203; B60R 21/235

(52) U.S. Cl. CPC B60R 21/239; B60R 21/2035; B60R 21/235; B60R 2021/23576; B60R 2021/2395

(57) ABSTRACT

An airbag device includes an airbag inflated by an inflation gas flowing into the airbag to protect an occupant seated in a seat on a vehicle. The airbag includes a bag main body and a control member. One end portion of the control member is connected to the bag main body by being sewn to the bag main body using a conductive thread. The control member controls an inflation state of the bag main body by maintaining or releasing a connected state of the one end portion of the control member to the bag main body using the conductive thread. The conductive thread is electrically connected to a control device. The connected state between the one end portion of the control member and the bag main body is released by dividing a predetermined portion of a sewn portion due to energization of the conductive thread.

### CROSS-REFERENCE TO RELATED APPLICATIONS

This application is based on and claims priority under 35 USC 119 from Japanese Patent Application No. 2024-214680 filed on Dec. 9, 2024, the entire content of which is incorporated herein by reference.

### TECHNICAL FIELD

The present disclosure relates to an airbag device including an airbag, in which the airbag is configured to be inflated by an inflation gas flowing into the airbag in order to protect an occupant seated in a seat, and an inflation state of the airbag is controlled. s

### BACKGROUND ART

In the related art, as the airbag device in which the inflation state of the airbag is controlled, there is an airbag device in which an exhaust hole portion is provided in an bag main body that is inflated to protect an occupant, and opening and closing of the exhaust hole portion is controlled by a separately provided actuator (for example, see JP2015-535504A). Specifically, in the airbag device in the related art, a small bag connected to the actuator is provided, and the exhaust hole portion is opened by inflating the small bag with a gas generated when the actuator is operated.

However, in the airbag device in the related art, since the inflation state of the airbag is controlled by using the actuator and the small bag connected to the actuator, the airbag device is not simple in configuration.

### SUMMARY OF INVENTION

An object of the present disclosure is to provide an airbag device capable of accurately protecting an occupant with a simple configuration.

An aspect of the present disclosure relates to an airbag device including an airbag, the airbag being configured to be inflated by an inflation gas flowing into the airbag to protect an occupant seated in a seat on a vehicle, and an inflation state of the airbag being controlled, in which
the airbag includes a bag main body and a control member configured to control an inflation state of the bag main body,
at least one end portion of the control member is connected to the bag main body by being sewn to the bag main body using a conductive thread, and the control member controls the inflation state of the bag main body by maintaining or releasing a connected state of the one end portion of the control member to the bag main body using the conductive thread,
a sewn portion in which the one end portion of the control member is connected to the bag main body is constituted of the conductive thread, and
the conductive thread is electrically connected to a control device, and is configured to allow the connected state between the one end portion of the control member and the bag main body to be released by dividing a predetermined portion of the sewn portion due to energization of the conductive thread.

In the airbag device of the aspect, the at least one end portion of the control member capable of controlling the inflation state of the bag main body is connected to the bag main body, and the control member controls the inflation state of the bag main body by maintaining or releasing the connected state to the bag main body. The one end portion of the control member is connected to the bag main body due to the sewn portion, and the sewn portion is constituted of the conductive thread. The conductive thread is electrically connected to the control device, and is capable of releasing a sewn state (the connected state) by dividing the predetermined portion of the sewn portion due to energization of the conductive thread. That is, in the airbag device of the aspect, when the conductive thread constituting the sewn portion in which the one end portion of the control member is connected to the bag main body is energized at a predetermined time, the connected state between the one end portion of the control member and the bag main body can be released, and the inflation state of the bag main body can be changed by maintaining or releasing the connected state between the one end portion of the control member and the bag main body. Therefore, since the inflation state of the airbag (the bag main body) can be controlled without using a squib as in the airbag device in the related art, it is possible to achieve a simple configuration. In addition, it is possible to achieve a reduction in manufacturing cost and weight, and to achieve downsizing of the airbag device. Needless to say, also in the airbag device of the aspect, since the inflation state of the airbag can be controlled, the occupant can be accurately protected by the inflated airbag.

Therefore, the airbag device of the aspect can accurately protect the occupant with a simple configuration.

Specifically, in a case in which the sewn portion includes a needle thread and a bobbin thread, at least one of the needle thread or the bobbin thread may be constituted of the conductive thread.

### BRIEF DESCRIPTION OF DRAWINGS

Exemplary embodiment(s) of the present invention will be described in detail based on the following figures, wherein:

FIG. 1 is a schematic view illustrating the vicinity of a part in which an airbag device for a steering wheel according to an embodiment of the present disclosure is mounted;

FIG. 2 is a schematic plan view of the steering wheel on which the airbag device according to the embodiment is mounted;

FIG. 3 is a schematic enlarged sectional view of the airbag device according to the embodiment in a front-rear direction;

FIG. 4 is a bottom view of an airbag, which is used in the airbag device according to the embodiment, in a flatly deployed state;

FIG. 5 is a longitudinal sectional view of the airbag of FIG. 4 taken along a line V-V of FIG. 4;

FIG. 6 is a partially enlarged bottom view illustrating portions of a flap member in the airbag of FIG. 4;

FIG. 7 is a schematic partially-enlarged sectional view illustrating a sewn portion in which a tip end of the flap member in the airbag of FIG. 4 is sewn to a vehicle body-side wall portion;

FIG. 8 is a plan view illustrating a state where base members constituting the airbag of FIG. 4 are arranged;

FIG. 9 is a schematic longitudinal sectional view illustrating a state where the airbag is fully inflated while a closed state of an exhaust hole achieved by the flap member is maintained in the airbag device according to the embodiment;

FIG. 10 is a partially-enlarged sectional view illustrating an inflation state of the airbag in a state where closing of the exhaust hole achieved by the flap member is released (a state where a connected state between the tip end of the flap member and the vehicle body-side wall portion is released) in the airbag device according to the embodiment; and

FIG. 11 is a partially-enlarged sectional view illustrating an inflation state of the airbag in a state where the closing of the exhaust hole achieved by the flap member is maintained (a state where the connected state between the tip end of the flap member and the vehicle body-side wall portion is maintained) in the airbag device according to the embodiment.

### DESCRIPTION OF EMBODIMENTS

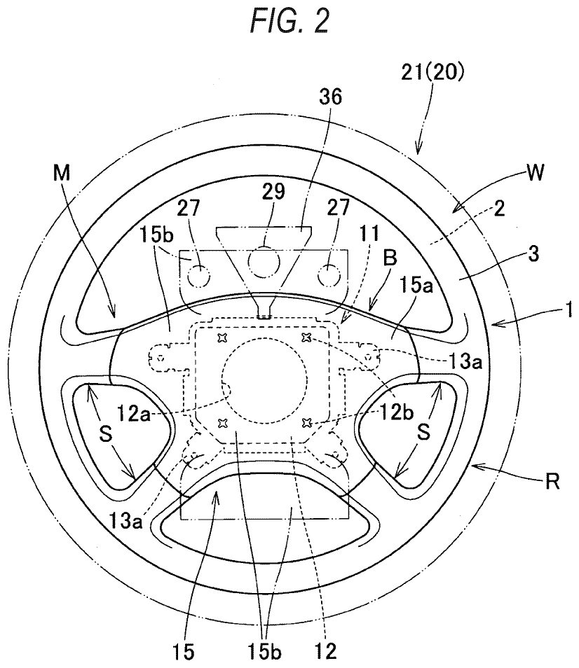

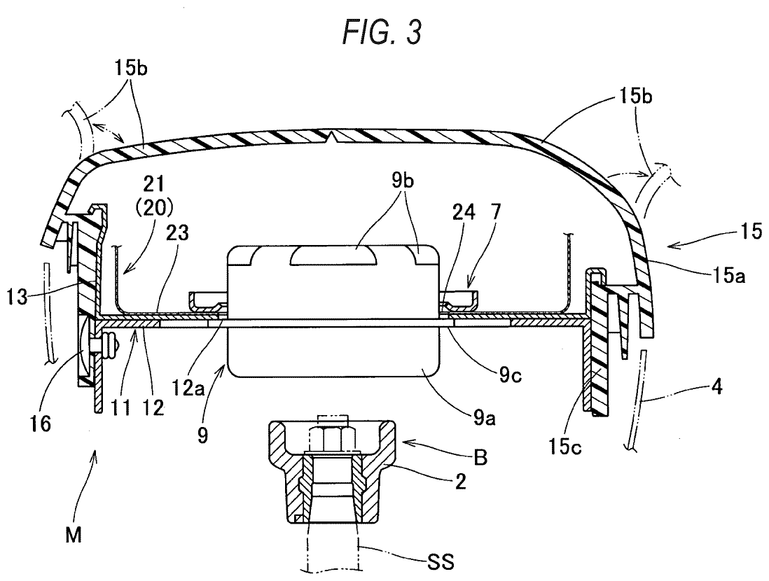

Hereinafter, an embodiment of the present disclosure will be described with reference to the drawings. In the embodiment, an airbag device M mounted on a steering wheel W will be described as an example. In the airbag device M according to the embodiment, regarding a control of an inflation state of a bag main body 21 (to be described later) of an airbag 20, a configuration for controlling an internal pressure of the bag main body 21 at the time of full inflation will be described as an example. As illustrated in FIGS. 2 and 3, the steering wheel W includes a steering wheel main body 1 and the airbag device M disposed above a boss portion B at the center of the steering wheel main body 1. In the case of the embodiment, the steering wheel main body 1 includes a ring portion R that is gripped at the time of steering, the boss portion B that is disposed substantially at the center of the ring portion R and is connected to a steering shaft SS, and a plurality of (four in the case of the embodiment) spoke portions S that connect the boss portion B and the ring portion R.

In the embodiment, unless otherwise specified, front, rear, up, down, right and left directions are specified based on straight-ahead steering of the steering wheel W mounted on a vehicle, up and down directions along an axial direction of the steering shaft SS (see FIG. 2) to which the steering wheel W is assembled are defined as an up-down direction, front and rear directions of the vehicle as directions orthogonal to the axial direction of the steering shaft SS are defined as a front-rear direction, left and right directions of the vehicle as directions orthogonal to the axial direction of the steering shaft SS are defined as a left-right direction, and thus the front, rear, up, down, right and left directions are specified.

As illustrated in FIGS. 2, 3, and 9, the steering wheel main body 1 includes a cored bar 2 that is made of a metal such as an aluminum alloy and is disposed to connect the ring portion R, the boss portion B, and the spoke portions S, a coating layer 3 that is made of a synthetic resin and covers the cored bar 2 at the ring portion R and parts (not illustrated) of the spoke portions, and a lower cover 4 that is made of a synthetic resin and covers the lower side of the boss portion B.

As illustrated in FIG. 3, the airbag device M includes the airbag 20, an inflator 9 that supplies an inflation gas to the airbag 20, a case 11 that serves as an accommodation portion for accommodating and holding the folded airbag 20 and the inflator 9, an airbag cover 15 that covers the folded airbag 20, and a retainer 7 that attaches the airbag 20 and the inflator 9 to the case 11.

As illustrated in FIG. 3, the inflator 9 includes a substantially cylindrical main body portion 9a having a plurality of gas discharge ports 9b, and a flange portion 9c for attaching the inflator 9 to the case 11. Through holes (not illustrated) through which bolts (not illustrated) of the retainer 7 pass are formed in the flange portion 9c. The inflator 9 is electrically connected to a control device 60 to be described later.

As illustrated in FIG. 3, the case 11 serving as the accommodation portion is made of sheet metal, and includes a substantially rectangular plate-shaped bottom wall portion 12 to which the inflator 9 is inserted and attached from below, and a peripheral wall portion 13

extending vertically from an outer peripheral edge of the bottom wall portion 12. Attachment pieces 13a extending outward are formed at an upper end of the peripheral wall portion 13 (see FIG. 2). The airbag device M according to the embodiment is mounted above the boss portion B of the steering wheel main body 1 attached to the steering shaft SS by using an attachment substrate of a horn switch mechanism (not illustrated) attached to the attachment pieces 13a to attach and fix the case 11 to the cored bar 2 of the steering wheel W. In addition, a side wall portion 15c of the airbag cover 15 is attached to the peripheral wall portion 13 of the case 11 by using a rivet 16 or the like (see FIG. 3). In the case of the embodiment, the airbag 20 and the inflator 9 are attached to the bottom wall portion 12 of the case 11 by using the bolts (not illustrated) of the retainer 7 disposed in the airbag 20 as an attachment unit, passing the bolts through a peripheral edge of an inflow opening 24 in the airbag 20, the bottom wall portion 12 of the case 11, and the flange portion 9c of the inflator 9, and fastening the bolts with nuts (not illustrated). Although not illustrated in detail, insertion holes through which lead wires 45, 45 (to be described later) extending from the folded airbag 20 can be inserted are formed at predetermined portions in the case 11.

The airbag cover 15 is made of a synthetic resin, and includes a ceiling wall portion 15a that covers the upper side of the airbag 20 accommodated in the case 11, and the substantially square cylindrical side wall portion 15c that extends downward from the vicinity of an outer peripheral edge of the ceiling wall portion 15a (see FIGS. 2 and 3). The ceiling wall portion 15a is formed with two door portions 15b, 15b that are pushed by the inflated airbag 20 to open forward and backward.

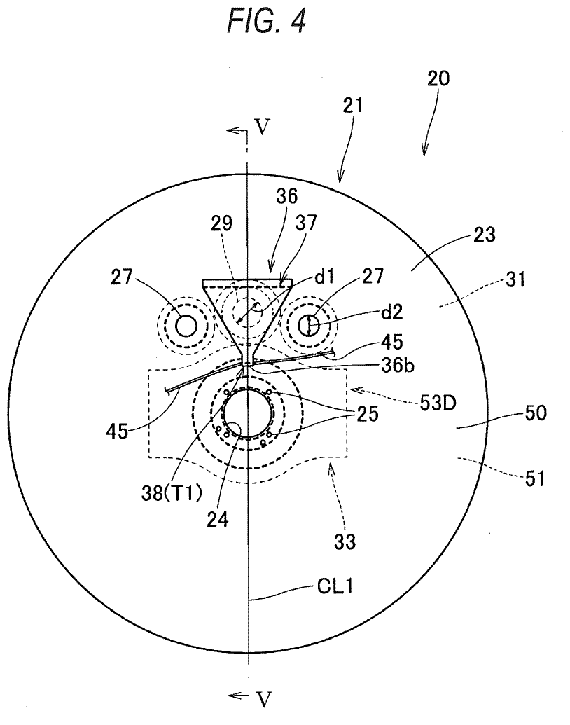

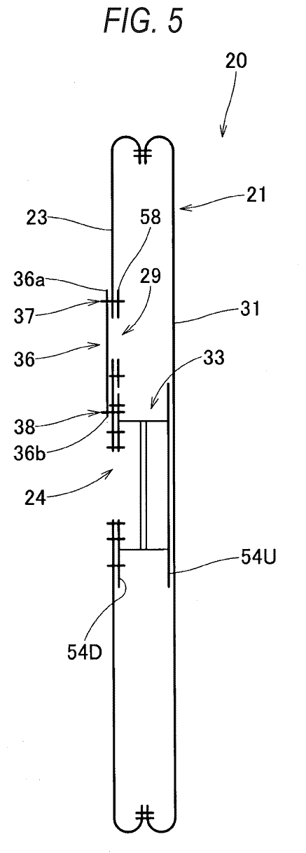

In the case of the embodiment, as illustrated in FIGS. 4 and 5, the airbag 20 includes the bag-shaped bag main body 21, a tether 33 that regulates a full-inflated shape of the bag main body 21, and a flap member 36 that serves as a control member (internal pressure control member) capable of controlling the inflation state of the bag main body 21 (specifically, capable of controlling the internal pressure at the time of full inflation).

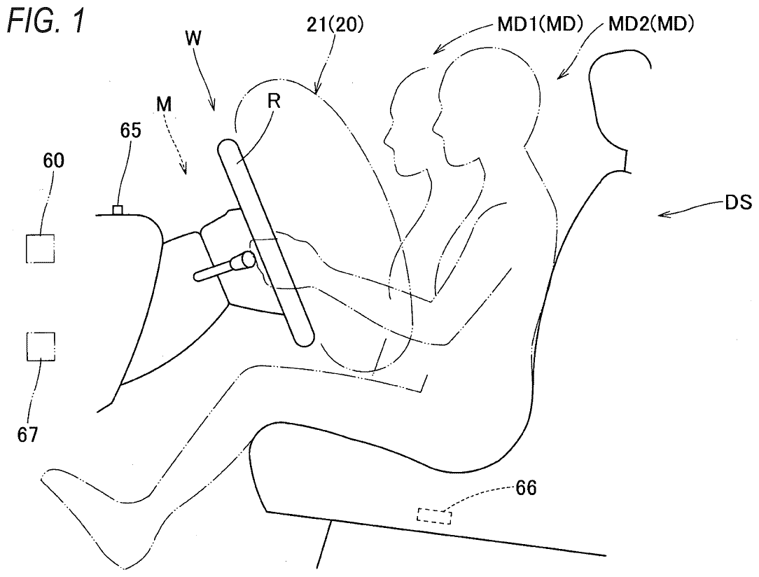

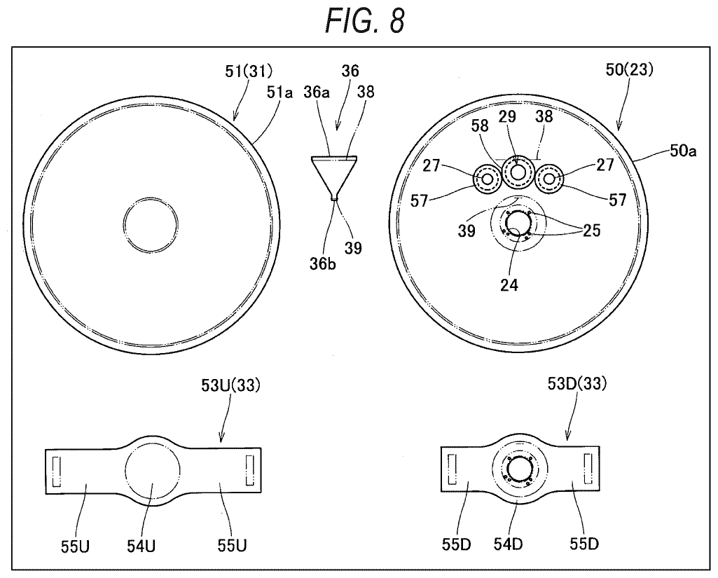

In order to cover an upper surface of the steering wheel W over substantially the entire surface at the time of full inflation, the bag main body 21 has the fully-inflated shape that is a substantially circular shape capable of covering the entire ring portion R when viewed from above and that is a substantially ellipsoidal shape when viewed from a side, as illustrated by the two-dot chain lines in FIGS. 1 and 2 and FIG. 9. As illustrated in FIGS. 4 and 5, the bag main body 21 includes a driver-side wall portion 31 disposed on a driver MD side and a vehicle body-side wall portion 23 disposed on a steering wheel W (vehicle body) side at the time of full inflation, and as illustrated in FIG. 8, the bag main body 21 is formed in a bag shape by joining (sewing using a sewing thread) outer peripheral edges 50a, 51a of a vehicle body-side panel 50 and a driver-side panel 51, which have substantially the same outer shape, that is, a substantially circular shape. The driver-side panel 51 and the vehicle body-side panel 50 constituting the bag main body 21 are formed of a flexible woven fabric made of polyamide yarn, polyester yarn, or the like.

In the bag main body 21, as illustrated in FIGS. 4 and 5, the inflow opening 24 through which the inflation gas can flow into the bag main body 21 is formed in a circular shape at substantially the center of the vehicle body-side wall portion 23. The main body portion 9a of the inflator 9 is inserted into the inflow opening 24 from below, and four attachment holes 25 through which the bolts (not illustrated) formed in the retainer 7 are inserted are formed in the peripheral edge of the inflow opening 24. Vent holes 27 for discharging the excess inflation gas flowed into the bag main body 21 are formed in the vehicle body-side wall portion 23 of the bag main body 21. In the case of the embodiment, the vent holes 27 are formed to be opened in a substantially circular shape, and are disposed at two places. Specifically, the vent holes 27 are disposed at bilaterally symmetrical positions with respect to a line CL (see FIG. 4) along the front-rear direction as a reference line, which passes through the center of the inflow opening 24, and are disposed in a region inside the ring portion R at the time of full inflation of the airbag 20 (see the two-dot chain line in FIG. 2).

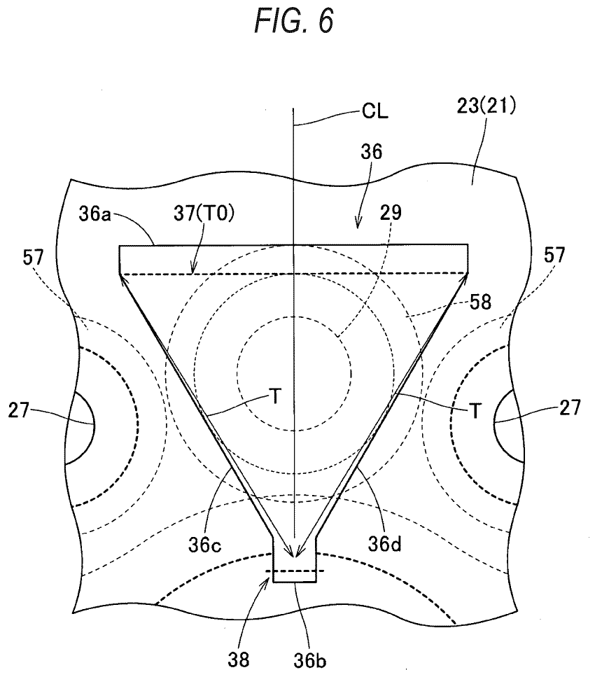

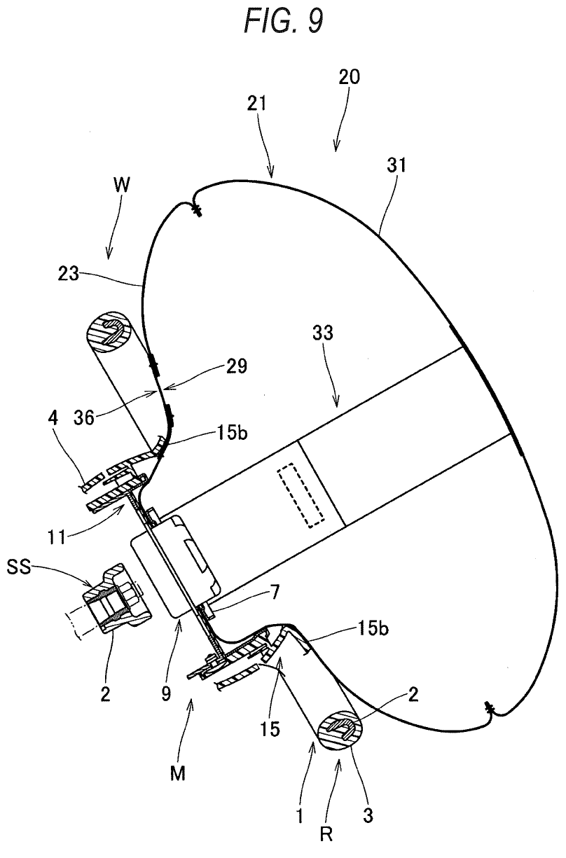

Further, in addition to the vent holes 27 that are always opened, an exhaust hole 29 that is opened and closed by the flap member 36 is formed in the vehicle body-side wall portion 23 of the bag main body 21. The exhaust hole 29 has a substantially circular opening shape, and in the case of the embodiment, the exhaust hole 29 is disposed at a position between the vent holes 27, 27 and in front of the inflow opening 24 (specifically, the center is located on the line CL) in a state where the bag main body 21 is flatly deployed (see FIGS. 4 and 6). In detail, the exhaust hole 29 and the vent holes 27, 27 disposed on the left and right sides of the exhaust hole 29 are disposed to be substantially radial around the inflow opening 24. More specifically, a separation distance of the exhaust hole 29 from the inflow opening 24 is set to be substantially equal to a separation distance of each vent hole 27 from the inflow opening 24, and the exhaust hole 29 is also disposed in the region inside the ring portion R at the time of full inflation of the bag main body 21, similarly to the vent holes 27 (see the two-dot chain line in FIG. 2 and FIG. 9). That is, the exhaust hole 29 is set to have a small curvature in a cross section at the time of full inflation, and is disposed in the substantially planar region. In the case of the embodiment, as illustrated in FIGS. 4 and 6, an opening area of the exhaust hole 29 is set to be larger than that of each vent hole 27. Specifically, in the case of the embodiment, an inner diameter d1 of the exhaust hole 29 is set to about 1.4 times an inner diameter d2 of each vent hole 27. In the embodiment, peripheral edges of the vent holes 27 and the exhaust hole 29 are reinforced by substantially annular reinforcing cloth 57, 58, respectively (see FIGS. 4 to 6, 8).

The tether 33 for regulating the fully-inflated shape of the bag main body 21 is disposed to connect the peripheral edge of the inflow opening 24 in the vehicle body-side wall portion 23 and the vicinity of the center of the driver-side wall portion 31, and regulates a separation distance between the vicinity of the center of the driver-side wall portion 31 and the peripheral edge of the inflow opening 24 at the time of full inflation, and in the embodiment, the tether 33 is formed at two positions, that is, the left side and the right side of the inflow opening 24. The tether 33 includes two tether base members 53U, 53D as illustrated in FIG. 8. The tether base members 53U, 53D respectively include attachment portions 54U, 54D that are joined to the vehicle body-side wall portion 23 and the driver-side wall portion 31, and two tether-forming portions 55U, 55D that extend from outer peripheral edges of the attachment portions 54U, 54D, and the tether 33 is formed by joining corresponding end portions of the tether-forming portions 55U, 55D to each other in a state where the attachment portions 54U, 54D are joined to the vehicle body-side wall portion 23 and the driver-side wall portion 31. Similarly to the bag main body 21, the tether base members 53U, 53D constituting the tether 33 are formed of a flexible woven fabric made of polyamide yarn, polyester yarn, or the like.

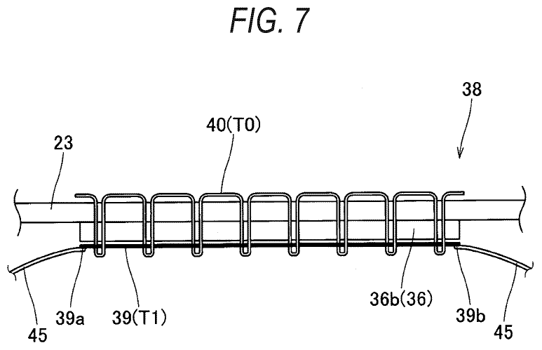

The flap member 36 serving as the control member (the internal pressure control member) can close the exhaust hole 29 formed in the bag main body 21, and in the case of the embodiment, as illustrated in FIGS. 4 and 5, the flap member 36 is disposed on an outer peripheral surface of the bag main body 21. Similarly to the bag main body 21 and the tether 33, the flap member 36 is formed of a flexible woven fabric made of polyamide yarn, polyester yarn, or the like. The flap member 36 is set to a size capable of closing the exhaust hole 29, and in the case of the embodiment, an outer shape thereof is a substantially isosceles triangle shape (see FIGS. 4 and 6). The flap member 36 is disposed to close the exhaust hole 29 from an outer peripheral surface side over the entire surface such that a base edge 36a as a bottom side is along the left-right direction in front of the exhaust hole 29, a tip end 36b is positioned behind the exhaust hole 29, and two oblique edges 36c, 36d are positioned on the left and right sides of the exhaust hole 29. The base edge 36a of the flap member 36 is sewn (joined) to the bag main body 21 (the vehicle body-side wall portion 23) over the entire length by using a sewing thread T0 so as to form a sewn portion 37. The tip end 36b of the flap member 36 is sewn (joined) to the bag main body 21 (the vehicle body-side wall portion 23) by using a conductive thread T1. Specifically, in the case of the embodiment, as illustrated in FIG. 7, a sewn portion 38 in which the tip end 36b of the flap member 36 is sewn to the vehicle body-side wall portion 23 includes a needle thread 39 and a bobbin thread 40. In the embodiment, of the needle thread 39 and the bobbin thread 40 constituting the sewn portion 38, the needle thread 39 disposed to be exposed on an outer surface side of the flap member 36 is constituted of the conductive thread T1, and the bobbin thread 40 disposed to be exposed on an inner surface side of the vehicle body-side wall portion 23 is constituted of the commonly used sewing thread T0 (specifically, a thread made of a synthetic fiber formed of polyamide yarn, polyester yarn, or the like). Then, the lead wires 45, 45 are connected to both ends of the sewn portion 38 in which the tip end 36b of the flap member 36 is sewn to the vehicle body-side wall portion 23 (specifically, end portions 39a, 39b on both sides of the needle thread 39 constituted of the conductive thread T1) (see FIG. 7), and the sewn portion 38 (the needle thread 39) is electrically connected to the control device 60 (see FIG. 1) provided in the vehicle body via the lead wires 45, 45. In the case of the embodiment, the conductive thread T1 (the needle thread 39) constituting the sewn portion 38 is energized via the lead wires 45, 45 when an operation signal from the control device 60 is received, and when the conductive thread T1 is energized, heat is generated to melt the sewing thread T0 (the bobbin thread 40), and the sewing thread T0 (the bobbin thread 40) is divided.

As illustrated in FIG. 1, the control device 60 is electrically connected to an occupant detection sensor capable of detecting a physique, a seating position, and the like of the driver MD as an occupant seated in a seat (driver's seat) DS (for example, a position detection sensor 65 capable of detecting a distance between the steering wheel W and the driver MD, and a weight detection sensor 66 capable of detecting the weight of the driver MD), and is electrically connected to a collision detection sensor 67 capable of detecting an acceleration, an acceleration direction, and the like of the vehicle. Then, the control device 60 receives an electric signal from the position detection sensor 65, the weight detection sensor 66, or the collision detection sensor 67 to operate the inflator 9, and energizes the conductive thread T1 (the needle thread 39) constituting the sewn portion 38 in which the tip end 36b of the flap member 36 is sewn to the vehicle body-side wall portion 23. The physique and the seating position of the driver MD may be detected by a camera capable of capturing an image of the driver's seat.

Next, manufacturing of the airbag 20 according to the embodiment will be described. In the vehicle body-side panel 50, the base edge 36a of the flap member 36 is sewn by using the sewing thread T0 to form the sewn portion 37 in advance, and the tip end 36b of

the flap member 36 is sewn by using the sewing thread T0 and the conductive thread T1 to form the sewn portion 38 in advance. Further, in the vehicle body-side panel 50, the sewing thread is sewn at a portion that overlaps the attachment portion 54D of the tether base member 53D and serves as the peripheral edge of the inflow opening 24, and the inflow opening 24 and the attachment holes 25 are formed by punching. The attachment portion 54U of the tether base member 53U is sewn to the driver-side panel 51 in advance. Next, when the vehicle body-side panel 50 and the driver-side panel 51 are overlapped in a flatly deployed state while outer surfaces thereof are brought into contact with each other, and the outer peripheral edges 50a, 51a are sewn to each other by using the sewing thread, the bag-shaped bag main body 21 in a state where the flap member 36 is attached can be formed. The airbag 20 can be manufactured by using the inflow opening 24 to invert the bag main body 21 so as not to expose sewing margins to the outside, and then joining tip ends of the tether-forming portions 55U, 55D to each other to form the tether 33.

The airbag 20 manufactured in this manner can be mounted on the vehicle in the following manner. The lead wires 45, 45 are connected to both ends of the sewn portion 38 in which the tip end 36b of the flap member 36 is sewn to the vehicle body-side wall portion 23 (the end portions 39a, 39b on both sides of the needle thread 39 constituted of the conductive thread T1), and the airbag 20 is folded to be accommodatable in the case 11 while maintaining a connected state of the lead wires 45, 45. Specifically, although not illustrated in detail, when the retainer 7 is disposed inside the airbag 20 (the bag main body 21) by protruding the bolts (not illustrated) from the attachment holes 25, the airbag 20 (the bag main body 21) is folded by reducing a width dimension in the front-rear and left-right directions to be accommodatable in the case 11 from a state where the airbag 20 is flatly deployed so that the vehicle body-side wall portion 23 and the driver-side wall portion 31 overlap each other, and at this time, the flap member 36 is also folded together with the bag main body 21. Then, the folded airbag 20 is accommodated in the case 11. At this time, the lead wires 45, 45 extending from the folded airbag 20 are previously inserted into the predetermined insertion holes (not illustrated) formed in the case 11. The inflator 9 and the airbag 20 are attached to the case 11

by inserting the main body portion 9a of the inflator 9 from below and using the bolts (not illustrated) protruding from the bottom wall portion 12 and the nuts. Further, the airbag device M can be assembled by covering the case 11 with the airbag cover 15, attaching the airbag cover 15 to the case 11 with the rivet 16 or the like, and assembling the horn switch mechanism (not illustrated) to the attachment pieces 13a of the case 11. The airbag device M can be mounted on the vehicle by using the attachment substrate (not illustrated) of the horn switch mechanism to attach the airbag device M to the steering wheel main body 1 fastened to the steering shaft SS in advance. When mounted on the vehicle, the inflator 9 and the lead wires 45, 45 extending from the tip end 36b of the flap member 36 in the airbag 20 are electrically connected to the control device 60.

In the airbag device M according to the embodiment, when the inflation gas is discharged from the gas discharge ports 9b of the inflator 9, the airbag 20 is inflated by the inflation gas flowing into the airbag 20 and then pushes and opens the door portions 15b, 15b of the airbag cover 15 to protrude from the case 11, and completes the inflation to cover the upper surface of the steering wheel W over substantially the entire surface as illustrated by the two-dot chain lines of FIGS. 1 and 2 and FIG. 9.

In the airbag device M according to the embodiment, at least one end portion of the control member (in the case of the embodiment, the flap member 36) capable of controlling the inflation state of the bag main body 21 is connected to the bag main body 21, and the control member controls the inflation state of the bag main body 21 by maintaining or releasing a connected state to the bag main body 21. The end (the tip end 36b) of the control member (the flap member 36) is connected to the bag main body 21 by the sewn portion 38, and the sewn portion 38 (in the case of the embodiment, the needle thread 39 constituting the sewn portion 38) is constituted of the conductive thread T1. Then, the conductive thread T1 is electrically connected to the control device 60, and a sewn state (the connected state) can be released by dividing a predetermined portion (in the case of the embodiment, the bobbin thread 40 constituted of the sewing thread T0) of the sewn portion 38 due to energization of the conductive thread T1. That is, in the airbag device M according to the embodiment, when the conductive thread T1 (the needle thread 39) constituting the sewn portion 38 that connects the at least one end (the tip end 36b) of the flap member 36 serving as the control member to the bag main body 21, is energized at a predetermined time, the connected state between the tip end 36b of the flap member 36 and the bag main body 21 can be released, and the inflation state of the bag main body 21 can be changed by maintaining or releasing the connected state between the tip end 36b of the flap member 36 and the bag main body 21. Therefore, since the inflation state of the airbag 20 (the bag main body 21) can be controlled without using a squib as in the airbag device in the related art, it is possible to achieve a simple configuration. In addition, it is possible to achieve a reduction in manufacturing cost and weight, and to achieve downsizing of the airbag device M. Needless to say, also in the airbag device M according to the embodiment, since the inflation state of the airbag 20 can be controlled, the driver MD as an occupant can be accurately protected by the inflated airbag 20.

Therefore, by the airbag device M according to the embodiment, the driver MD as an occupant can be accurately protected with a simple configuration.

Specifically, in the airbag device M according to the embodiment, the flap member 36 capable of closing the exhaust hole 29 formed in the bag main body 21 is provided as the control member (the internal pressure control member) capable of controlling the inflation state of the bag main body 21 (capable of controlling the internal pressure at the time of full inflation).

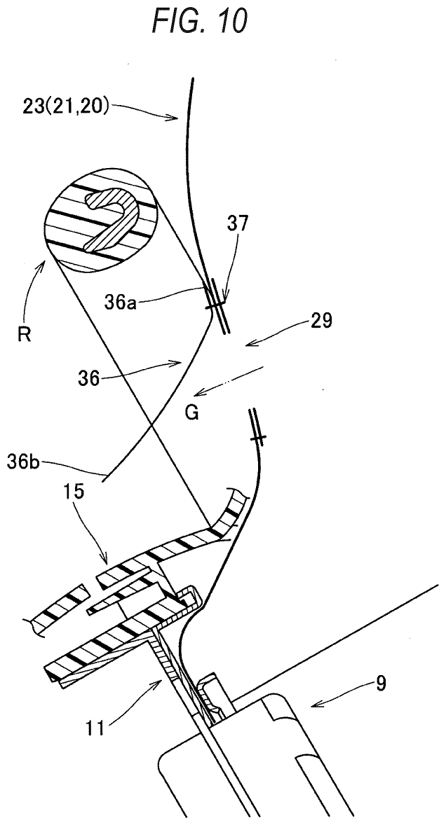

Further, in the airbag device M according to the embodiment, for example, when the control device 60, which receives the signals from the predetermined sensors 65, 66, and 67, detects that a small size driver MD1 is seated or detects that the driver MD is seated at a position close to the steering wheel W, substantially at the same time as the operation of the inflator 9, the conductive thread T1 (the needle thread 39) constituting the sewn portion 38 in which the tip end 36b of the flap member 36 is sewn to the vehicle body-side wall portion 23 is energized via the lead wires 45, 45, and the conductive thread T1 (the needle thread 39) generates heat to partially melt the sewing thread T0 (the bobbin thread 40), thereby dividing the sewing thread T0 (the bobbin thread 40). Then, due to occurrence of cast-off of the bobbin thread 40 by the division, the connected state (the sewn state) between the tip end 36b of the flap member 36 and the vehicle body-side wall portion 23 achieved by the sewn portion 38 is released, and as illustrated in FIG. 10, the airbag 20 is inflated in an opened mode in which the exhaust hole 29 is opened, and completes the inflation by discharging the excess inflation gas from the exhaust hole 29. Therefore, since the airbag 20 discharges the excess inflation gas from the exhaust hole 29 and completes the inflation in a state where an increase in the internal pressure is restrained, with the airbag 20 whose internal pressure is set to be low, it is possible to restrain the small size driver MD1 or the driver MD seated close to the steering wheel W from being pressed more than necessary and to softly protect the small size driver MD1 or the driver MD.

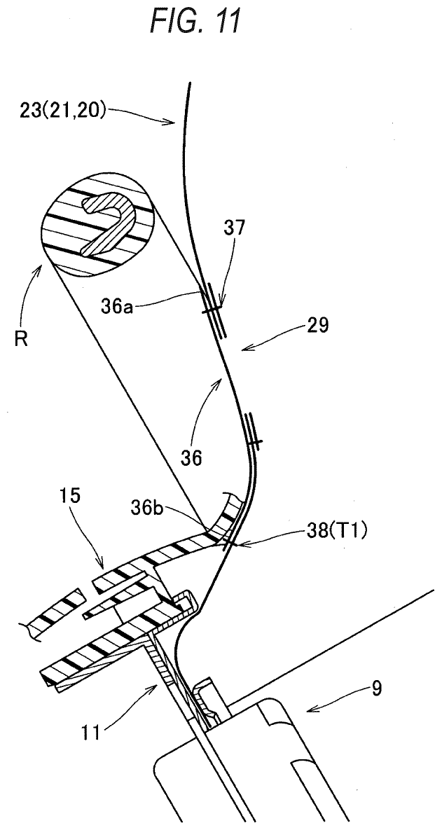

Conversely, for example, when the control device 60 detects that a large size driver MD2 is seated or detects that the driver MD is seated at a position relatively away from the steering wheel W, the conductive thread T1 (the needle thread 39) constituting the sewn portion 38 in which the tip end 36b of the flap member 36 is sewn to the vehicle body-side wall portion 23 is not energized, the sewn portion 38 is maintained, and the airbag 20 is inflated in a closed mode in which the closed state of the exhaust hole 29 achieved by the flap member 36 is maintained, and completes the inflation while the closed state of the exhaust hole 29 is maintained as illustrated in FIG. 11. Therefore, since the airbag 20 is fully inflated in a high internal pressure state where the inflation gas is not discharged from the exhaust hole 29, the large size driver MD2 or the driver MD seated relatively away from the steering wheel W can be accurately protected by the inflated airbag 20 ensuring the sufficient internal pressure and having a good cushioning property, without being bottomed.

In the airbag device M according to the embodiment, the flap member 36 is formed in a substantially isosceles triangle shape, the base edge 36a as the bottom side is sewn (joined) to the vehicle body-side wall portion 23 over the entire length, and the tip end 36b as a vertex is sewn by using the conductive thread T1. Then, at the time of inflation in the closed mode in which the closed state of the exhaust hole 29 achieved by the flap member 36 is maintained, the flap member 36 closes the exhaust hole 29 provided in the bag main body 21 by applying tensions T (see FIG. 6) to the vicinity of the two edges 36c, 36d as oblique sides, along the edges 36c, 36d (along lines connecting end portions of the sewn portions 37, 38), respectively. According to the embodiment, in the vehicle body-side wall portion 23 of the bag main body 21, the exhaust hole 29 is formed in the region disposed at a position inside the ring portion R of the steering wheel W at the time of full inflation. Since such a region is disposed in a substantially planar shape in the bag main body 21 at the time of full inflation, the exhaust hole 29 and the flap member 36 that closes the exhaust hole 29 from the outside are also disposed in the region disposed in a substantially planar shape in the vehicle body-side wall portion 23 of the airbag 20 (the bag main body 21) at the time of full inflation. Therefore, when the airbag 20 is inflated in a state (the closed mode) in which the connected state between the tip end 36b of the flap member 36 and the vehicle body-side wall portion 23 achieved by the sewn portion 38 is maintained, the tensions T are applied to the vicinity of the edges 36c, 36d of the flap member 36, but a gap is less likely to occur between tension generation portions (portions on the edges 36c, 36d side) and the vehicle body-side wall portion 23, and gas leakage from the exhaust hole 29 can be restrained as much as possible. That is, in the airbag device M according to the embodiment, even when the flap member 36 is set to the isosceles triangle shape, the exhaust hole 29 can be stably closed.

Further, disposition positions of the flap member 36 and the exhaust hole 29, and the outer shape of the flap member 36 are not limited to the embodiment. The flap member 36 and the exhaust hole 29 may be disposed in an outer peripheral edge-side region located on the outer peripheral side of the ring portion R in the vehicle body-side wall portion 23 of the bag main body 21 at the time of full inflation. In addition, the flap member 36 may also be set to a substantially square shape, the sewn portion 38 (a connected portion achieved by the conductive thread T1) at the tip end 36b may be disposed over the entire length of the flap member 36 in a width direction, and further, the flap member 36 may be disposed on an inner peripheral surface of the bag main body 21.

In the airbag device M according to the embodiment, the two vent holes 27, 27 that are always opened are disposed in the airbag 20 separately from the exhaust hole 29, but the presence or absence of the vent hole that is always opened is not particularly limited. The presence or absence, the size, the number, and the like of the vent hole can be appropriately changed according to an occupant protection mode. Further, according to the embodiment, the airbag device M for a steering wheel is described as an example, but the airbag device to which the present disclosure can be applied is not limited to a steering wheel, and the present invention may be applied to, for example, an airbag device for a passenger seat. In addition, according to the embodiment, the flap member 36 capable of closing the exhaust hole 29 provided in the bag main body 21 is provided as the control member capable of controlling the inflation state of the bag main body 21, and the flap member 36 controls the internal pressure of the airbag 20 at the time of full inflation, but the control of the inflation state of the airbag 20 (bag main body 21) is not limited to internal pressure control. For example, a configuration may be adopted in which a protruding inflation portion that can be inflated to partially protrude from the bag main body 21, or the like is provided as the control member to make the fully-inflated shape different, and an end of the tether 33 or the like that pulls the protruding inflation portion is connected to the bag main body 21 by a conductive thread to make the fully-inflated shape different according to a mode.

In the airbag device M according to the embodiment, the sewn portion 38 in which the tip end 36b of the flap member 36 is sewn to the bag main body 21 includes the needle thread 39 and the bobbin thread 40, only one thread (the needle thread 39) is constituted of the conductive thread T1, and the other thread (the bobbin thread 40) is constituted of the common sewing thread T0, but the form of the sewn portion 38 is not limited to the embodiment. For example, the sewn portion 38 may not include two threads, that is, the needle thread 39 and the bobbin thread 40, and may be formed of only one thread constituted of the conductive thread. Further, both the needle thread 39 and the bobbin thread 40 constituting the sewn portion 38 may be formed of the conductive thread. In addition, according to the embodiment, the needle thread 39 constituted of the conductive thread T1 generates heat and melts the bobbin thread 40 constituted of the common sewing thread T0 to divide the predetermined portion, but the conductive thread itself may divide the predetermined portion by melting due to heat generation without melting the sewing thread.

What is claimed is:

1. An airbag device including an airbag, the airbag being configured to be inflated by an inflation gas flowing into the airbag to protect an occupant seated in a seat on a vehicle, and an inflation state of the airbag being controlled, wherein
the airbag includes a bag main body and a control member configured to control an inflation state of the bag main body,
at least one end portion of the control member is connected to the bag main body by being sewn to the bag main body using a conductive thread, and the control member controls the inflation state of the bag main body by maintaining or releasing a connected state of the one end portion of the control member to the bag main body using the conductive thread,
a sewn portion in which the one end portion of the control member is connected to the bag main body is constituted of the conductive thread, and
the conductive thread is electrically connected to a control device, and is configured to allow the connected state between the one end portion of the control member and the bag main body to be released by dividing a predetermined portion of the sewn portion due to energization of the conductive thread.

2. The airbag device according to claim 1, wherein
the sewn portion includes a needle thread and a bobbin thread, and
at least one of the needle thread or the bobbin thread is constituted of the conductive thread.
